(19) United States
(12) Patent Application Publication
(10) Pub. No.: US 2016/0172876 A1
(43) Pub. Date: Jun. 16, 2016

(54) CHARGER FOR FIREARM ELECTRONICS

(71) Applicant: Yardarm Technologies, Inc., Capitola, CA (US)

(72) Inventors: Robert J. Stewart, Soquel, CA (US); David Glowacki, San Francisco, CA (US); James Schaff, Pacifica, CA (US); Tom Tooley, Alpharetta, GA (US); Kyle Howell, Atlanta, GA (US); John Wade, Alpharetta, GA (US)

(21) Appl. No.: 14/970,109

(22) Filed: Dec. 15, 2015

Related U.S. Application Data
(60) Provisional application No. 62/092,153, filed on Dec. 15, 2014.

(51) Int. Cl. H02J 7/00; F41A 35/00

(52) U.S. Cl. CPC H02J 7/007; F41A 35/00; H02J 7/0052

(57) ABSTRACT

Disclosed herein are apparatuses, systems, methods, and machine readable media for using a charging device for delivering electrical power to components of a firearm. The charging device may be shaped to resemble an ammunition magazine. This form facilitates a simple and secure connection to the firearm by repurposing magazine attachment mechanisms already present on or within the firearm. The charging device may be inserted into the firearm while it is not in use, providing power to the firearm's electronics and/or batteries thereof. The charging unit is then removed, leaving the firearm mechanically unchanged and ready for normal operation and use.

### CROSS-REFERENCE TO RELATED APPLICATIONS

This application claims the benefit of U.S. Provisional Application No. 62/092,153, filed Dec. 15, 2014, which is incorporated by reference in its entirety.

### FIELD OF THE INVENTION

The present invention relates to apparatuses, systems, computer readable media, and methods for using an improved mechanism for providing electricity to electronic circuitry within a firearm.

### BACKGROUND

Although fundamentally mechanical in their operation, modern firearms increasingly make use of electronic circuitry. Sometimes these electronics are embedded in the firearm itself, and other times they are found in accessories attached to the firearm; examples include tactical lights and lasers, electronic scopes, and onboard computer and sensor arrays. With such electronics may come the need for electrical power, most commonly delivered by rechargeable or replaceable batteries.

The need to recharge or replace such batteries imposes compromises on the design of said electronic accessories. These design compromises introduce drawbacks—for example, allowances must be made to facilitate access to the battery or means of charging (e.g., either by removing the accessory from the firearm entirely, removing the battery from the accessory, or connecting a charging cable to the accessory). Moreover, providing readily accessible charging sockets and/or battery compartments can compromise an accessory's resistance to water, dust, and debris. Additionally, frequent removal and reattachment of the accessory to the firearm is inconvenient and a source of increased wear and fragility.

There is a need for devices and systems that facilitate charging of a wide variety of firearm electronics that avoid or minimize these drawbacks. Disclosed herein are embodiments of an invention that address those needs.

### BRIEF DESCRIPTION OF THE DRAWINGS

The above and other aspects and advantages of the invention will become more apparent upon consideration of the following detailed description, taken in conjunction with the accompanying drawings, in which like reference characters refer to like parts throughout, and in which:

FIG. 1 shows views of a charging device, in accordance with some embodiments of the invention;

FIG. 2 shows views of a charging device, in accordance with some embodiments of the invention;

FIG. 3 shows views of a firearm with a charging device, in accordance with some embodiments of the invention;

FIG. 4 shows a block diagram of a charging device in communication with a mobile device, in accordance with some embodiments of the invention;

FIG. 5 shows three exemplary user interfaces for use in a system including a charging device, in accordance with some embodiments of the invention;

FIG. 6 shows an exemplary user interface for use in a system including a charging device, in accordance with some embodiments of the invention;

FIG. 7 shows an exemplary user interface for use in a system including a charging device, in accordance with some embodiments of the invention;

FIG. 8 is a block diagram showing exemplary data flows for an exemplary system in accordance with some embodiments of the invention;

FIG. 9 is a flow chart depicting an exemplary method for charging a firearm accessory, in accordance with some embodiments of the invention;

FIG. 10 is a block diagram showing an exemplary mobile computing device, consistent with some embodiments of the invention;

FIG. 11 is a block diagram showing an exemplary computing device, consistent with some embodiments of the invention;

FIG. 12 is a block diagram showing an exemplary computing system, consistent with some embodiments of the invention.

### DETAILED DESCRIPTION

Disclosed herein are devices/apparatuses, systems, methods, and machine readable media for implementing and using an improved mechanism for providing power to electronic circuitry within a firearm. Embodiments of the present invention provide a charging unit for a firearm, such as a semi-automatic handgun or rifle, shaped to resemble the form of an ammunition magazine or clip for the firearm. As the shape of an ammunition magazine or clip varies between specific firearms, so too can the charging unit be shaped for individual makes and models of firearms.

As used herein, a “firearm” refers to a ranged weapon, including a handgun, rifle, Taser®, Conducted Electrical Weapon (CEV), or additional types of weapons capable of firing a bullet. Certain embodiments of the disclosure may be specifically adapted for one or more of handguns, rifles, or Tasers.

As used herein, a “firearm accessory” refers to an electronic device requiring power that is mounted on or within a firearm. In certain embodiments, firearm accessories may be a telemetry sensor, a laser sight, a fingerprint sensor, a pressure sensor, a taclight (tactical light), a tactical laser, an electronic scope, an onboard computer, sensor arrays, and the like.

As used herein, a “charging device” refers to a removable charging unit for delivering electrical power to a firearm accessory.

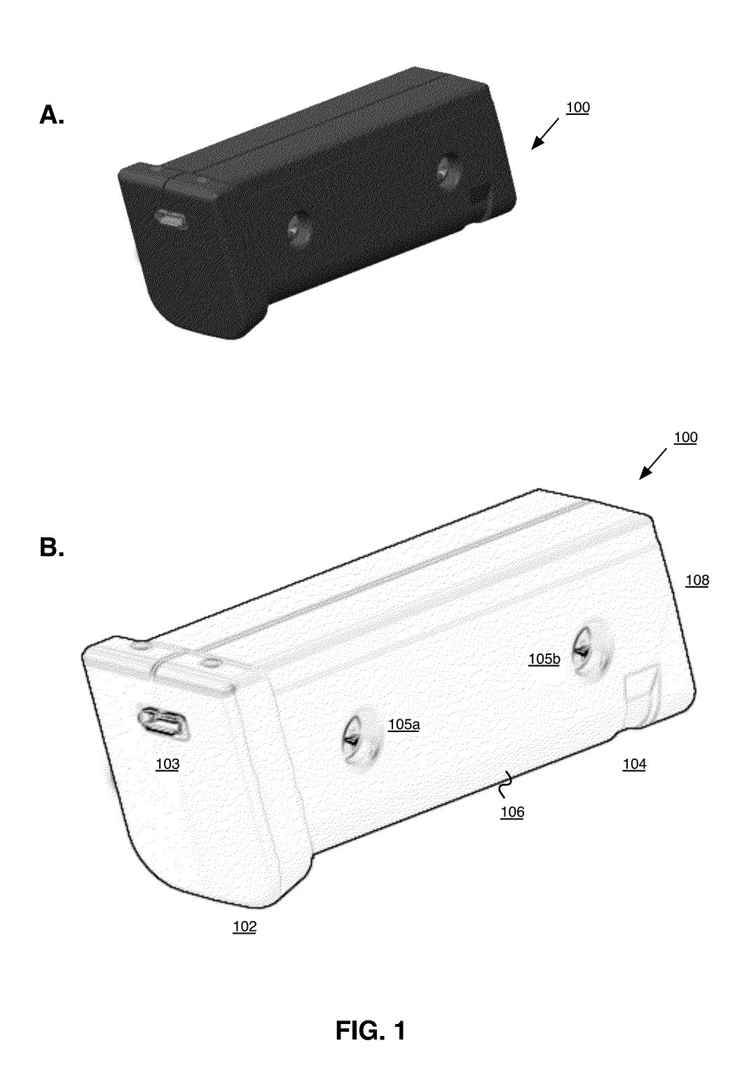

FIG. 1 shows two depictions of an exemplary charging device 100. In the embodiments shown in FIG. 1, device 100 is generally shaped to resemble the outer contour of the magazine for a Glock™ handgun. In FIG. 1B, charging device 100 is shown to include a base 102 at the proximal end of device 100, with a port 103 to receive power and/or data. Base 102 refers to the portion of device 100 that may be exposed when device 100 is mounted to a firearm. Base 102 may include one or more visual indicators such as lights to indicate the status of device 100 (e.g., a solid or flashing green or red light may indicate that the device 100 is currently charging a device, that it is powered on but not currently charging, that it is wirelessly paired or unpaired with another device, and the like). Port 103 may be, e.g., a coaxial power connector, a Universal Serial Bus (USB) port, a microUSB port, a Lightning™ port, and the like. Device 100 may include a locking mechanism to secure the charging device 100 within the empty magazine chamber of a firearm—e.g., it may include a notch 104 that interacts with a magazine catch. Device 100 may further include bolts 105 to help hold together the housing 106 of device 100. The distal end 108 of device 100 may be inserted into a magazine chamber.

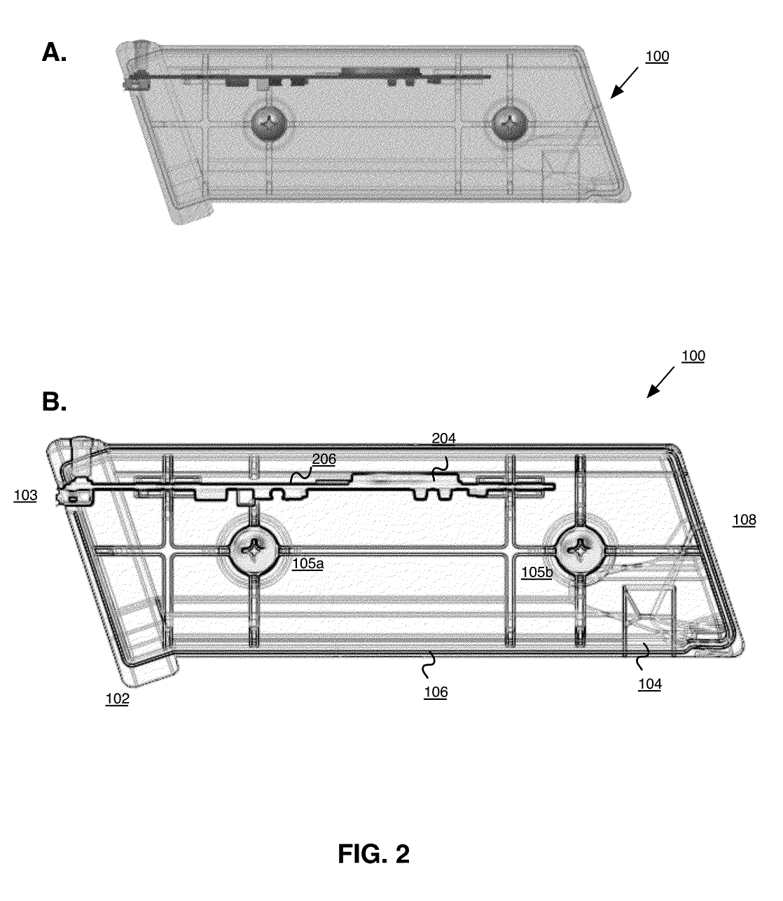

FIG. 2 shows side-profile views of an exemplary charging device 100. As shown in FIG. 2B, base 102 may include port 103, such that port 103 is directly or indirectly in communication with an inductive charging coil 204 and companion circuitry 206 mounted on an internal circuit board.

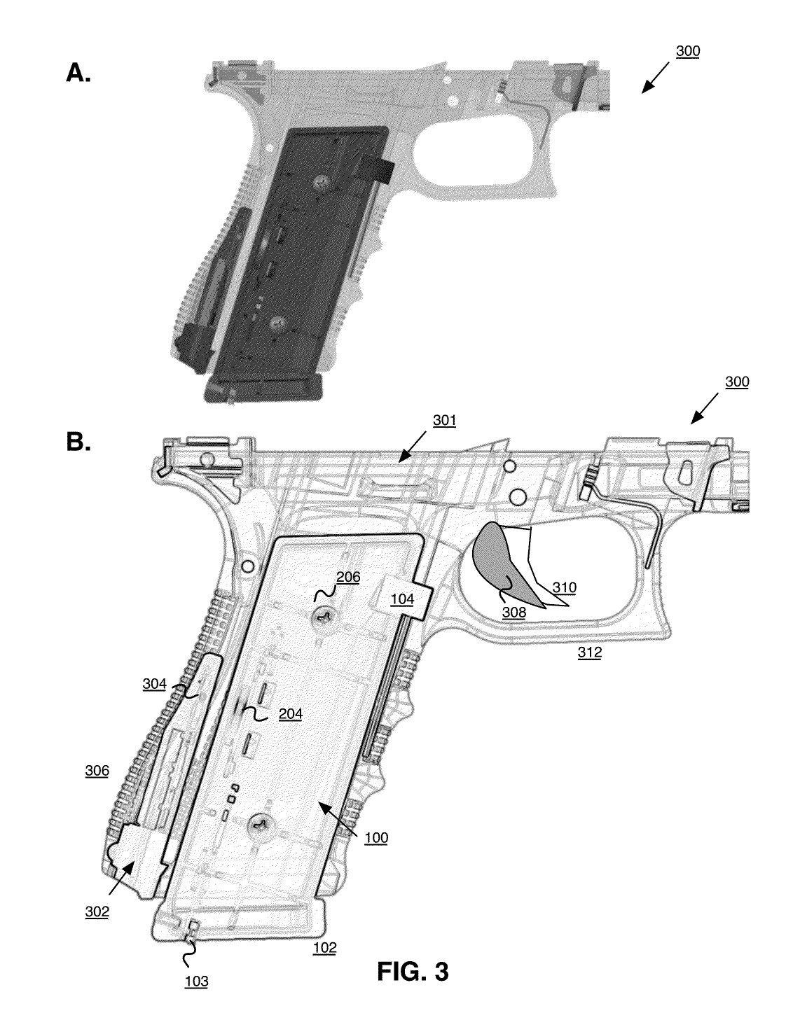

FIG. 3 shows side profile views of an exemplary system 300 including a handgun 301, a firearm accessory device 302, and a charging device 100. Upon removal of a magazine or clip from a firearm, the charging device 100 may be inserted into the empty magazine chamber as shown in FIG. 3. A protrusion (e.g., a lip) at base 102 of device 100 forms a tight coupling with the opening to the handgun 301 magazine chamber. Upon insertion, the charging device 100 may be secured within the magazine chamber using the same means by which an actual ammunition magazine or clip is secured (e.g., notch 104 that may interact with a spring-loaded magazine catch). In certain embodiments, the device 100 is secured within the magazine chamber using an after-market catch or latch, or by placing the firearm onto a mount supporting the device 100. FIG. 3 shows an exemplary firearm accessory device 302 (e.g., a sensor device that is attached to handgun 301 through insertion into an existing cavity within grip 306, by comprising a grip replacement for a firearm, or by attachment to or integration within a backstrap replacement for a firearm). Exemplary accessory device 302 contains a power receiving coil 304 that is positioned proximal to and parallel to inductive charging coil 204 of charging device 100. In certain embodiments, the entire housing 106, or just the portion of housing 106 between coils 204 and 304 may be formed from plastic or another low dielectric material to facilitate transmission of current between the coils. In certain embodiments, the portion of housing 106 between the coils may be thinner than other portions of the housing 106.

In certain embodiments, the charging coil 204 or receiving coil 304 may be stacked with one or more layers of windings. In certain embodiments, the coil is formed from copper, silver, or gold. In certain embodiments, the coil windings of coil 204 and coil 304 may range from 17 to 27 winds, for example, 22 winds. In certain embodiments, the gauge of the wire in coil 204 and coil 304 may range from 28-32 gauge, for example, 30 gauge or 0.266 mm. In certain embodiments, the inductive charging coil is formed using integrated traces upon a printed circuit board.

In certain embodiments, the charging device 100 may detect when it has been inserted into a firearm and initiate operation. For example, charging device 100 may automatically start to charge a firearm accessory upon insertion. In certain embodiments, insertion of the device 100 may cause a switch to be physically flipped, causing device 100 to activate. In certain embodiments, the charging device 100 will activate (e.g., begin charging an accessory) in response to a manually triggered event or control. For example, in certain embodiments, base 102 contains a switch that may used to activate charging when switched on. In certain embodiments, device 100 may receive a signal from a mobile device or a server instructing device 100 to activate. In certain embodiments, device 100 may detect that it is within close proximity to an accessory device 302 (e.g. e.g., with detection based on radio frequency identification (RFID), Near Field Communication (NFC), Bluetooth Low Energy (BLE) or iBeacon™ protocols between the device 100 and accessory device 302), and may activate accordingly.

In certain embodiments, charging device 100 may automatically power down or stop charging when accessory device 302 is fully charged in order to facilitate thermal management and avoid overheating. In certain embodiments, charging device 100 may incorporate a heat sink.

In certain embodiments, charging device 100 may be used to power two or more accessory devices 302 either simultaneously or in parallel. For example, charging device 100 may inductively power one or more accessory devices and additionally support lines out from device 100 to power/charge additional accessory devices.

In certain embodiments, upon insertion of charging device 100, the firing mechanism of the firearm is disabled. In certain embodiments, the firing mechanism of the firearm is disabled only during active charging. For example, handgun 301 may include a trigger 308 and trigger safety 310, such that in normal operation, a finger is inserted into the trigger guard 312 and used to pull trigger 308 to fire a bullet from the handgun. In certain embodiments, device 100 may physically interfere with the firing mechanism when mounted on or within a firearm. For example, in certain embodiments, device 100 may include a protrusion on or near the distal end 108 that interferes with the movement of the trigger mechanism of the firearm once it is secured in place, or as it is being inserted into a magazine cavity. In certain embodiments, device 100 may include an extending structure that arrests trigger bar movement. Such a mechanism may prevent or reduce accidental discharge of the firearm during handling of the firearm, and/or while charging.

In certain embodiments, electricity is supplied to the charging device 100 by means of a socket, plug, or wire connection at a location on the charging device which remains exposed when inserted into a firearm (e.g., port 103). In some embodiments, the charging device 100 may accept electrical power in the form of alternating current (AC) and convert this current as required by means of an embedded AC to direct current (DC) conversion circuit. In certain embodiments, the device 100 will accept power from an already-converted DC power source. Some embodiments may make use of common power and plug standards, such as the USB power specification and connector. In certain embodiments, the charging device 100 may receive power from a solar panel.

In certain embodiments, the charging unit supplies electrical power to batteries and/or electronics in or attached to a firearm, such as a firearm accessory. In some embodiments, power is provided to the circuitry by means of direct connection, such as metal leads or contacts in direct physical proximity to similar contacts within the firearm, to form a closed circuit. In other embodiments, the charging device 100 may provide power by means of wireless transmission. For example, as shown in FIGS. 2-3, an exemplary handgun variant of the charging device 100 is portrayed with an inductive charging coil 204 that functions as a power transmitting antenna. In certain embodiments, when supplied with power, the charging device 100 activates its circuitry (e.g. companion circuitry 206) and transmits power via charging coil 204. As depicted in FIG. 3, an exemplary electronic firearm accessory 302 is able to receive power from the charging device 100 by way of its own power receiving coil 304. In certain embodiments, charging device 100 includes a rechargeable battery, and the battery of device 100 may be charged separately from the accessory, and then later device 100 may be inserted into a firearm to supply power to the accessory using the charge in the rechargeable battery.

In certain embodiments, the system may be used to charge an accessory overnight. In certain embodiments, the system may be used to charge the battery of an accessory within 8 hours, within 6 hours, within 4 hours, within 2 hours, within 1 hour, or within 30 minutes.

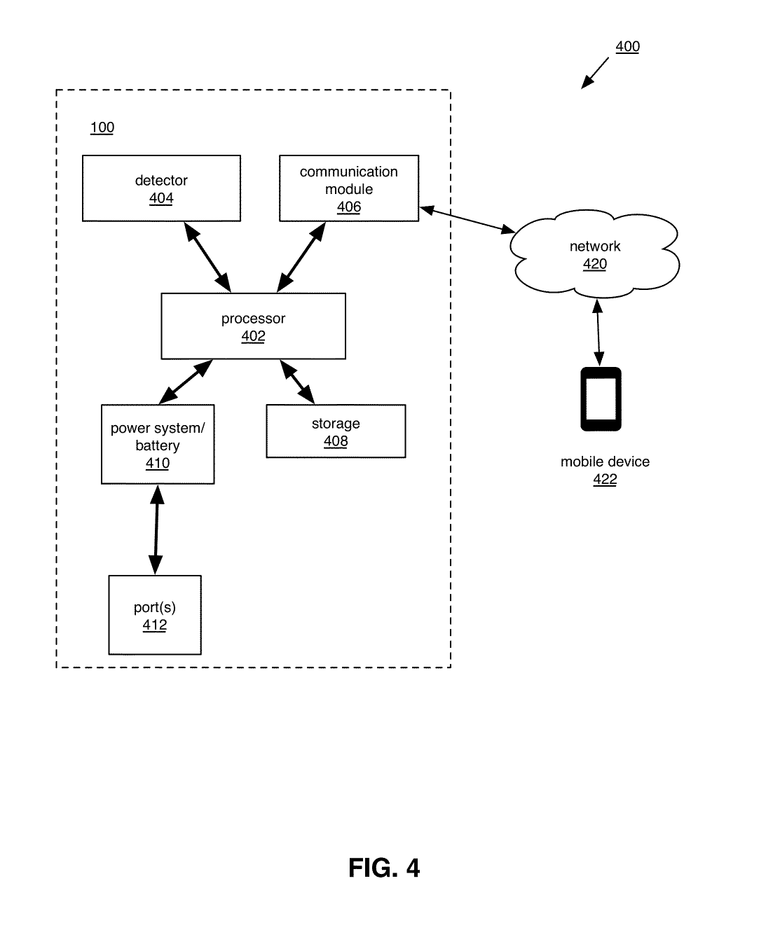

FIG. 4 shows a block diagram of an exemplary system 400 comprising an exemplary charging device 100 in communication with a mobile device 422. Charging device 100 includes a processor 402 that may be in communication with a detector 404, a communication module 406, a storage component 408, and a power system and/or battery 410. The power system/battery 410 is in communication with one or more port(s) 412 (e.g., port 103 described above).

Charging device 100 may include a detector 404—e.g., a temperature sensor for monitoring thermal load, or a mechanism for detecting over-current or over-voltage or other improper charging conditions which would adversely affect the battery. Communication module 406 may include a subscriber identity module (SIM) card, cellular radio, Bluetooth radio, NFC radio, wireless local area network (WLAN) radio, GPS receiver, and antennas used by each for communicating data over various networks. Storage 408 may include one or more types of computer readable medium, such as RAM, optical storage devices, or flash memory, and may store an operating system, applications, and communication procedures. The power system/battery 410 may include a power management system, one or more power sources such as a battery and recharging system, AC, DC, a power status indicator, and the like.

In certain embodiments, charging device 100 is in communication with a mobile device 422 via a network 420. (In certain embodiments, charging device 100 is alternately or additionally in communication with a remote server (not shown in FIG. 4)). Network 420 may include a local area network (LAN), wired or wireless network, private or public network, or the internet. In one example, mobile device 422 may be used to monitor or control the activity state of charging device 100.

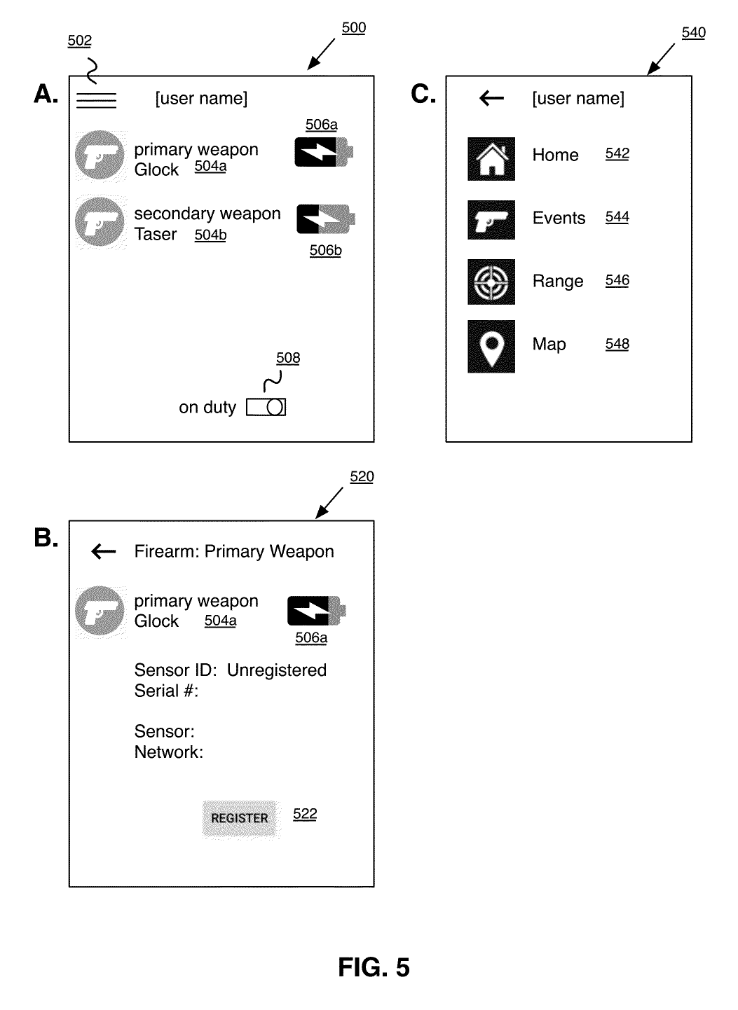

FIG. 5 shows three exemplary user interfaces for use in a system including a charging device 100. FIG. 5A shows a user interface 500 displaying a list of firearms 504 available in a firearm remote monitoring system. In one embodiment of such a system, each firearm 504 is associated with a battery-powered accessory device, and the status of the battery for each device is shown using icons 506. As shown, the accessory device associated with firearm 504a has greater charge remaining than firearm 504b. In certain embodiments, user interface 500 could further display the charging status for one or more accessory devices (e.g., charging, not charging, firearm/accessory co-localized with charging device 100 vs. separated from charging device, etc.). User interface 500 further includes an on-duty toggle 508 to control whether the system should monitor the associated firearms in “on duty mode” vs. “off duty mode”. For example, a user may desire an alert message to be provided to the user and additional recipients such as a supervisor when the firearm/accessory are separated from the charging device in “off duty mode”, because this may indicate that the firearm is potentially in use but is not authorized to be in use. Embodiments of the system may be configured to generate such a message. User interface 500 may further provide a drop-down menu 502 to access additional options, e.g., user interface 540 shown in FIG. 5C.

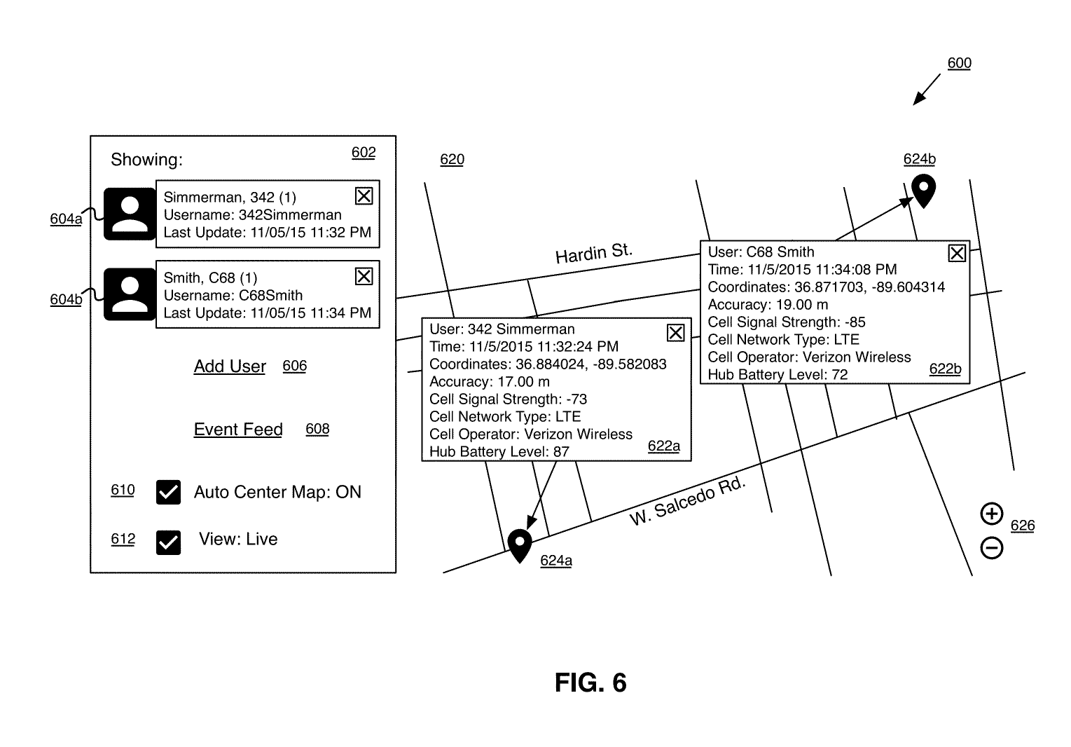

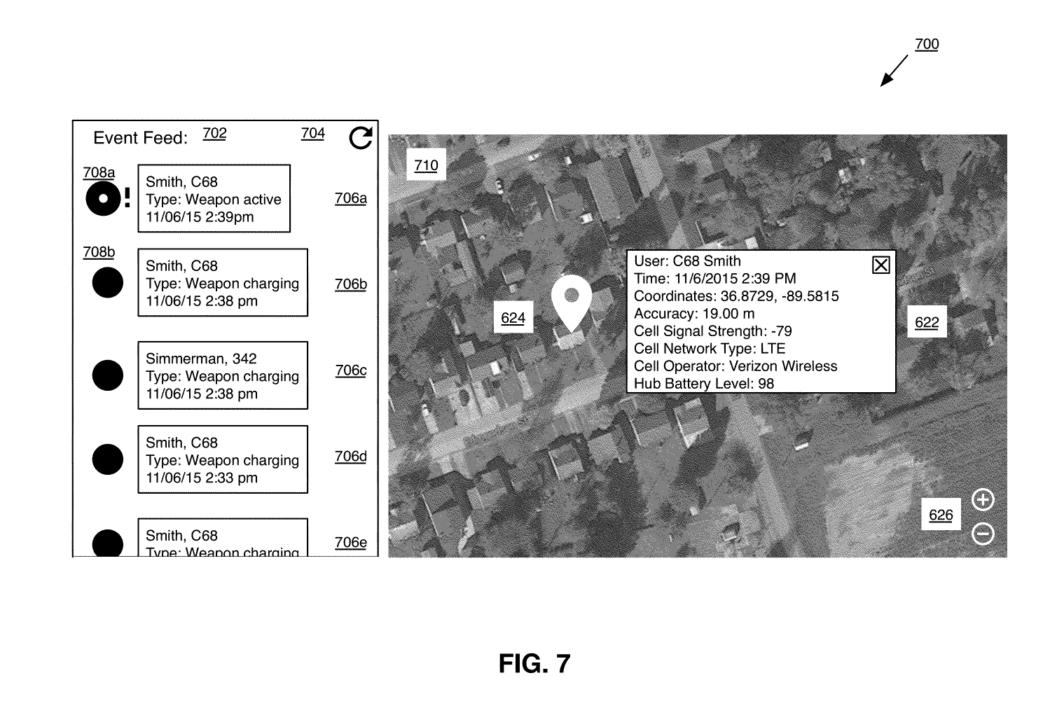

In some embodiments, selecting a particular firearm 504 in user interface 500 may display user interface 520, shown in FIG. 5B. User interface 520 may be used to register an accessory device 302 upon selecting register button 522. Such an interface may be further modified to display additional information about the charging status for the accessory device 302 that is associated with firearm 504a, and/or the corresponding charging device 100, as described above with respect to FIG. 5A. User interface 520 may also display additional information about a firearm and its associated system components—e.g., accessory devices 302, charging devices 100, hub devices. A hub device may be a mobile device that is paired with or local to devices 302 and/or 100, e.g., mobile device 422. For example, the information may include the location of each component plotted on a map, the serial number or ID for the components, the user associated with each component, whether/how each component is connected to a network and/or links to other UIs for displaying such information, such as the interfaces shown in FIGS. 6-7).

FIG. 5C shows an exemplary user interface 540 providing access to a home link 542, an events link 544 (see, e.g., FIG. 7), a range link 546 concerning a gun range, and a map link 548 for accessing a display of the locations of system components (see, e.g., FIGS. 6-7).

FIG. 6 shows an exemplary user interface 600 for use in a system including a charging device 100. Such an interface may be used for displaying the locations of system components (e.g., a firearm and associated accessory devices 302 and charging devices 100). Panel 602 provides a listing of two users 604a and 604b; components associated with those users are displayed on a map in panel 620. Panel 602 further provides a link 606 to add an additional user to the display, and a link 608 to access an event feed (see FIG. 7). Toggle 610 controls a map centering option and toggle 612 controls whether the display in panel 620 updates to display live information or stops refreshing.

Map panel 620 marks the location of the components associated with the users on the map using location markers 624. The map may be stylized as shown, or may constitute a satellite photograph. A user may adjust the scale of the map using controls 626. Additional information associated with the components at each location 624 is displayed in an overlay window 622. For example, the overlay window 622 provides information about (1) the user associated with the component(s) at the location; (2) the time stamp associated with the information; (3) the coordinates of the location; (4) the accuracy/error estimate for the location; (5) information about the network type, strength, and operator; (6) hub device battery status. In certain embodiments, additional information about charging status could be provided as well.

FIG. 7 shows an exemplary user interface 700 for use in a system including a charging device 100. User interface 700 may be used to view an event feed (panel 702) alongside the locations associated with each event (displayed in panel 710, showing a satellite image for the map). Panel 702 may display individual events 706 (e.g., status change from “Weapon active” to “Weapon charging”, or the reverse, or simply a list of the status for each component being monitored each time it is reported by a hub device or directly from another component such as a charging device 100), along with additional information such as the associated user name, a time stamp, and the event type. Events may be associated with icons 708 to quickly indicate the category of event. An event feed may be manually refreshed using a control 704—for example, in certain embodiments, this may cause the system to poll each component to report its current status, or in other embodiments, it may update the list of components being tracked and/or displayed in user interface 700.

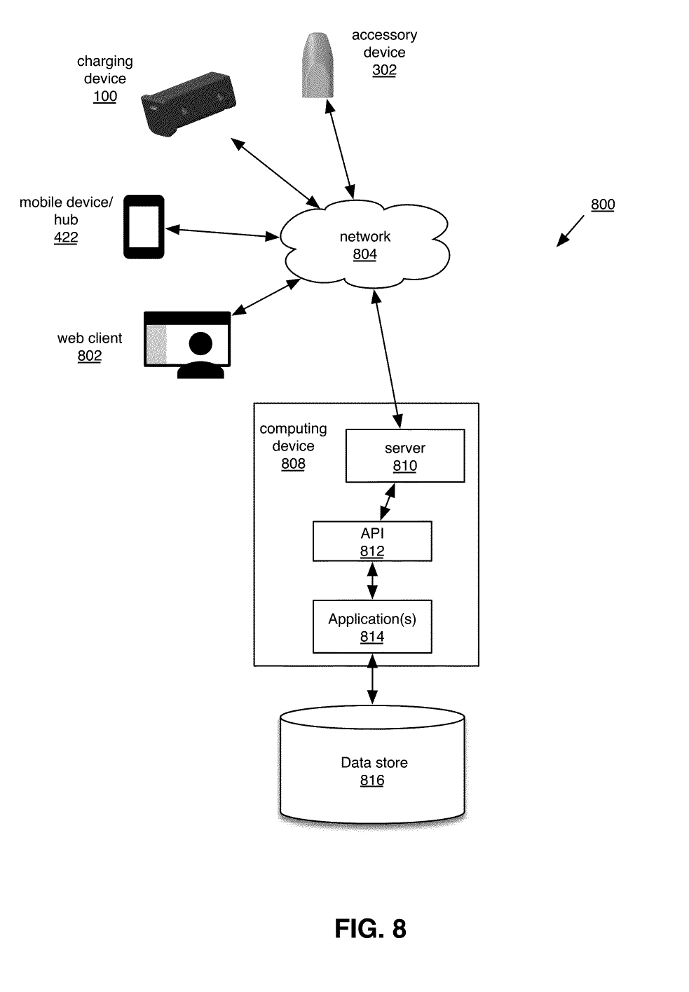

FIG. 8 is a block diagram showing exemplary data flows for an exemplary system 800. In certain embodiments, data regarding the status of a component may be generated at charging device 100, accessory device 302, and/or mobile device/hub 422. In certain embodiments, this data may be shared between components of the system (e.g., charging device 100, accessory device 302, mobile device 422) on a local area network such as a Bluetooth network even in the absence of a wireless connection providing communication with geographically remote devices (e.g., the device executing web client 802 or computing device 808 hosting server 810).

In certain embodiments, mobile device 422 may be a radio, such as a police radio, and web client 802 may be executed at a command and control center (e.g., for police, military, or security professionals).

All components of the system 800 are directly or indirectly connected using a combination of communication protocols represented by network 804. Network 804 may include a LAN, wired or wireless network, private or public network, or the internet, including wireless communication protocols such as General Packet Radio Service (GPRS), Enhanced Data rates for GSM Evolution (EDGE), 3G, 4G, Long Term Evolution (LTE) protocols, and communication standards such as Project 25 (P25), Terrestrial Trunked Radio (TETRA), and satellite and/or field radio protocols.

In certain embodiments, one or more computing devices 806 hosts a server 810, such as an HTTP server, and an application 812 that implements aspects of the remote monitoring system (e.g., a situational intelligence platform). For example, status-related files and/or user account information may be stored in data store 816. Application 814 may support an Application Programming Interface (API) 812 providing external access to methods for accessing data store 816. In certain embodiments, client applications running on on client devices 100, 302, 422, and 802 may access API 812 via server 810 using protocols such as HTTP or FTP.

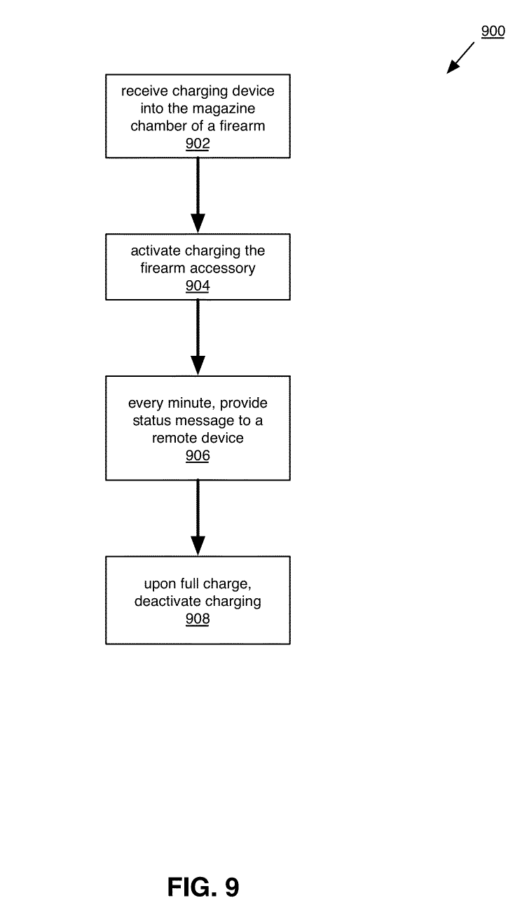

FIG. 9 is a flow chart depicting an exemplary process 900 for charging a firearm accessory. The process begins when a charging device 100 is received into a magazine chamber of a firearm (902). The charging device 100 may automatically detect it has been inserted into the magazine and/or is in position to charge an accessory, and activate charging (904). In certain embodiments, if the charging device 100 has a low battery or is not plugged into a power source, charging device 100 or accessory device 302 may provide an error message to mobile device 422 or computing device 806. While the accessory is being charged, charging device 100 or accessory device 302 may provide a status message to mobile device 422 or computing device 806 on a regular basis (906). For example, the charging device 100 or accessory device 302 may report charging status every second, every 5 seconds, every 30 seconds, every minute, every 5 minutes, or every 15 minutes. In certain embodiments, mobile device 422 or computing device 806 may poll the status of charging device 100 or accessory device 302 every second, every 5 seconds, every 30 seconds, every minute, every 5 minutes, or every 15 minutes. When accessory device 302 is fully charged, charging device 100 automatically deactivates charging (908). In certain embodiments, the system components continue to receive charging status updates before and/or after the charging process is active.

In certain embodiments, an instruction to activate or deactivate charging may be received from mobile device 422 or computing device 806. Such a request may be initiated by web client 802.

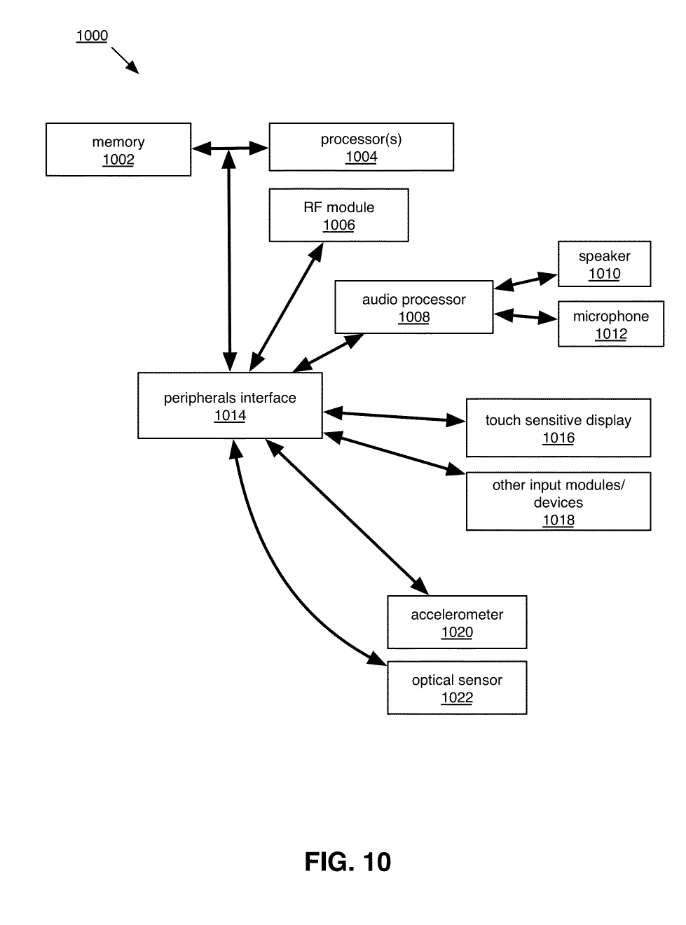

FIG. 10 is a block diagram showing an exemplary mobile computing device (e.g., mobile device 422). The device 1000 may have a memory 1002 which may include one or more types of computer readable medium, such as RAM, optical storage devices, or flash memory. Memory 1002 may store an operating system, applications, and communication procedures. Device 1000 may include one or more data processors, image processors, or central processing units 1004. Device 1000 may include peripherals interface coupled to RF module 1006, audio processor 1008, touch sensitive display 1016, other input modules/devices 1018, accelerometer 1020 and optical sensor 1022.

RF module 1006 may include a cellular radio, Bluetooth radio, NFC radio, WLAN radio, GPS receiver, and antennas used by each for communicating data over various networks.

Audio processor 1008 may be coupled to a speaker 1010 and microphone 1012. Touch sensitive display 1016 receives touch-based input. Other input modules or devices 1018 may include, for example, a stylus, voice recognition via microphone 1012, or an external keyboard.

Accelerometer 1020 may be capable of detecting changes in orientation of the device, or movements due to the gait of a user. Optical sensor 1022 may sense ambient light conditions, and acquire still images and video.

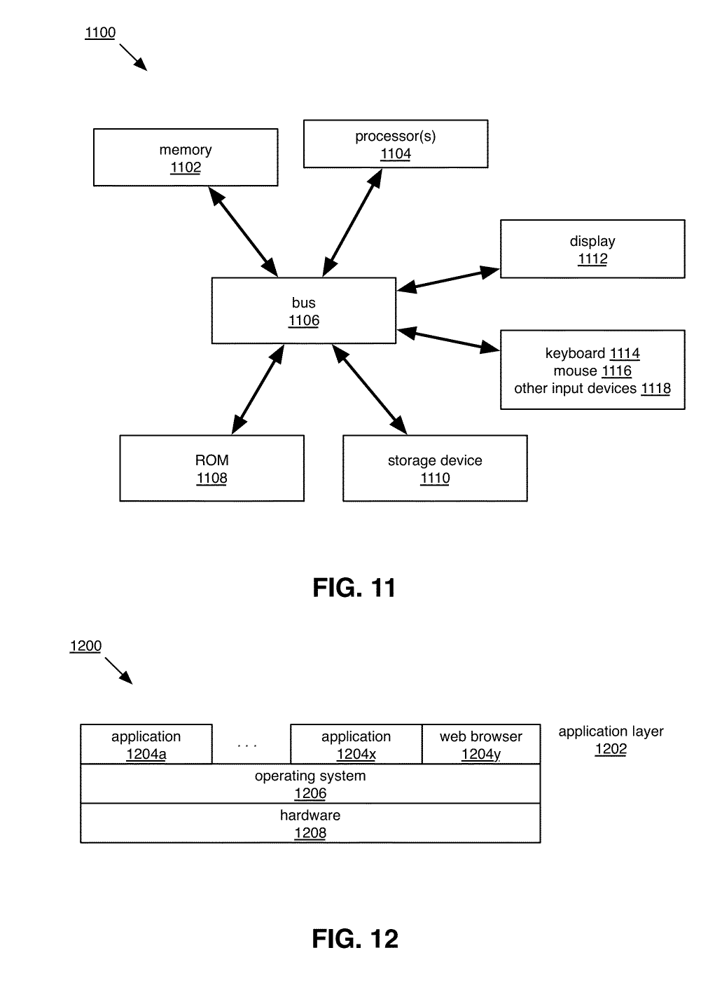

FIG. 11 is a block diagram showing an exemplary computing system 1100 that is representative any of the computer systems or electronic devices discussed herein. Note, not all of the various computer systems have all of the features of system 1100. For example, systems may not include a display inasmuch as the display function may be provided by a client computer communicatively coupled to the computer system or a display function may be unnecessary.

System 1100 includes a bus 1106 or other communication mechanism for communicating information, and a processor 1104 coupled with the bus 1106 for processing information. Computer system 1100 also includes a main memory 1102, such as a random access memory or other dynamic storage device, coupled to the bus 1106 for storing information and instructions to be executed by processor 1104. Main memory 1102 also may be used for storing temporary variables or other intermediate information during execution of instructions to be executed by processor 1104.

System 1100 includes a read only memory 1108 or other static storage device coupled to the bus 1106 for storing static information and instructions for the processor 1104. A storage device 1110, which may be one or more of a hard disk, flash memory-based storage medium, magnetic tape or other magnetic storage medium, a compact disc (CD)-ROM, a digital versatile disk (DVD)-ROM, or other optical storage medium, or any other storage medium from which processor 1104 can read, is provided and coupled to the bus 1106 for storing information and instructions (e.g., operating systems, applications programs and the like).

Computer system 1100 may be coupled via the bus 1106 to a display 1112 for displaying information to a computer user. An input device such as keyboard 1114, mouse 1116, or other input devices 1118 may be coupled to the bus 1106 for communicating information and command selections to the processor 1104.

The processes referred to herein may be implemented by processor 1104 executing appropriate sequences of computer-readable instructions contained in main memory 1104. Such instructions may be read into main memory 1104 from another computer-readable medium, such as storage device 1110, and execution of the sequences of instructions contained in the main memory 1104 causes the processor 1104 to perform the associated actions. In alternative embodiments, hard-wired circuitry or firmware-controlled processing units (e.g., field programmable gate arrays) may be used in place of or in combination with processor 1104 and its associated computer software instructions to implement the invention. The computer-readable instructions may be rendered in any computer language including, without limitation, Objective C, C#, C/C++, Java, assembly language, markup languages (e.g., HTML, XML), and the like. In general, all of the aforementioned terms are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 1100 or similar electronic computing device, that manipulates and transforms data represented as physical (electronic) quantities within its registers and memories into other data similarly represented as physical quantities within its memories or registers or other such information storage, transmission or display devices.

FIG. 12 illustrates a computer system 1200 from the point of view of its software architecture. Computer system 1200 may be any of the electronic devices or, with appropriate applications comprising a software application layer 1202, may be a computer system for use with the monitoring system described herein. The various hardware components of computer system 1200 are represented as a hardware layer 1208. An operating system 1206 abstracts the hardware layer and acts as a host for various applications 1204, that run on computer system 1200. The operating system may host a web browser application 1204y, which may provide access for the user interfaces, etc.

The foregoing description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” and the like are used merely as labels, and are not intended to impose numerical requirements on their objects.

What is claimed is:

1. A system for charging a firearm accessory, comprising:
a firearm;
the firearm accessory, wherein the accessory is mounted on or within the grip of the firearm; and
a charging device located within the magazine chamber of the firearm receiver.

2. The system of claim 1, wherein the charging device is secured within the magazine chamber by way of a standard magazine catch.

3. The system of claim 1, wherein the charging device comprises an inductive charging coil.

4. The system of claim 1, wherein the charging device forms a direct connection with the accessory by positioning contacts on the accessory in physical proximity to contacts on the charging device.

5. The system of claim 1, wherein the accessory comprises circuitry configured to provide and receive communications with a remote device over a wireless subsystem.

6. The system of claim 1, wherein the charging device comprises circuitry configured to provide and receive communications communications with a remote device over a wireless subsystem.

7. The system of claim 1, wherein the charging device disables the firing mechanism of the firearm upon securing the charging device within the magazine chamber.

8. The system of claim 2, wherein the charging device comprises a protrusion that physically interferes with movement of the trigger mechanism of the firearm.

9. The system of claim 3, wherein the inductive charging coil is formed using a stacked winding or is formed using integrated traces upon a printed circuit board.

10. The system of claim 1, wherein the time to charge the accessory is less than 8 hours.

11. The system of claim 1, wherein the system automatically halts charging when the accessory reaches a target charge level.

12. The system of claim 1, wherein the charging device comprises a rechargeable battery.

13. The system of claim 1, wherein the charging device includes visual indicators that show the status of charging.

14. A method for charging a firearm accessory, comprising:
at a firearm having a firearm accessory positioned proximal to the magazine chamber of the firearm, receiving a charging device into the magazine chamber of the firearm;
at the firearm, automatically commencing charging the firearm accessory upon receipt of the charging device into the magazine chamber;
at the firearm, each time a time interval has elapsed, providing a status message to a remote device, wherein the status message comprises an indication that the firearm accessory is charging or the firearm accessory is not charging;
at the firearm, automatically halting charging of the firearm accessory when the firearm accessory is fully charged.

15. The method of claim 14, wherein the status message further comprises information about the amount of remaining battery charge for a battery of the firearm accessory, or the rate of charging for the battery of the firearm accessory.

16. The method of claim 14, wherein the status message is provided by the firearm accessory.

17. The method of claim 14, wherein the status message is provided by the charging device.

18. The method of claim 14, wherein the method further comprises receiving, at the firearm, a message to activate or deactivate charging of the firearm accessory, and activating or deactivating charging accordingly.

19. The method of claim 14, wherein the remote device is a mobile device.

20. The method of claim 14, wherein the remote device is a server.
